(19) United States
(12) Patent Application Publication
(10) Pub. No.: US 2005/0129250 A1
(43) Pub. Date: Jun. 16, 2005

(54) Virtual assistant and method for providing audible information to a user

(75) Inventors: Roland Aubauer, Munchen (DE); Christoph Euscher, Rhede (DE)

Correspondence Address: BELL, BOYD & LLOYD, LLC, P. O. BOX 1135, CHICAGO, IL, 60690-1135, US

(73) Assignee: Siemens Aktiengesellschaft, Munich (DE)

(21) Appl. No.: 10/501,361

(22) PCT Filed: Jul. 17, 2003
(86) PCT No.: PCT/DE03/00078

(30) Foreign Application Priority Data
Jan. 14, 2002 (DE) 102 01 072.2

(51) Int. Cl. H04R 5/00

(52) U.S. Cl. 381/17

(57) ABSTRACT

A virtual assistant is provided which outputs audible information to a user of a data terminal. A method is also provided for presenting audible information of a virtual assistant to the user of a data terminal. At least two electroacoustic converters are driven such that the virtual assistant can be spatially positioned by a data terminal use to achieve acoustic separation between the electroacoustic converters and an additional sound source.

### BACKGROUND OF THE INVENTION

The invention relates to a virtual assistant, which outputs audible information to a user of a data terminal by means of at least two electroacoustic converters, and a method for presenting audible information of a virtual assistant for a user of a data terminal.

When using PC application programs, it is generally known that the user can make use of a virtual assistant. A virtual assistant is a computer-based help program that supports the user when carrying out the steps necessary to perform a task on the computer. The virtual assistant may also be invoked when the user needs further explanations about the capabilities of the PC application program. The virtual assistant may also direct the user's attention to any input mistakes the user makes and may make suggestions to the user. The information provided by the virtual assistant is presented to the user visually, that is to say by means of a display unit.

In principle, the functions of a virtual assistant which are helpful to a user can also be applied to mobile data terminals such as mobile phones or handheld terminals that are known as Personal Digital Assistants (PDAs). In this case, however, the extensive user of visual data by a traditional virtual assistant is a disadvantage due to the small display unit of the mobile data terminal.

Moreover, the extensive amount of information presented visually by a virtual assistant is difficult for the user of a handheld data terminal to process in situations where the user must concentrate on other visually presented information presented in the same vicinity or on acoustic information simultaneously presented such as an ongoing conversation with an associate. In this case it is expedient to provide the information presented by the virtual assistant to the data terminal user by means of an acoustic presentation. In this way, the data terminal user can more easily process the acoustically presented information along with the other information being simultaneously presented either visually or accoustically.

In other applications, data terminals are employed where additional information is acoustically presented to the user accoustically. For instance, an audio assistant in a ticket machine may be used to guide a user of the ticket machine through the respective operating programs of the ticket machine. However, such ticket machines and like devices are often sited in noisy environments. It is often difficult for users of the ticket machine to hear the acoustic information output by the audio assistant of the ticket machine and follow the instructions being presented.

An additional complicating factor in presenting acoustic information is that it is even more difficult to follow acoustic information that is simultaneously acting on a user from two different signal sources. So-called binaural technology has been the subject of research for some time now. For example, an introduction to binaural technology is described under the title: “An introduction to binaural technology” by J. Blauert (1996) in Binaural and Spatial Hearing in Real and Virtual Environments, edited by R. Gilkey & T. Anderson, pages 593-609, Lawrence Erlbaum, USA-Hilldale N.J.

With the aid of binaural technology, signal processing of the sound information can be employed to give, the listener the sense that the sound-generating source is assigned to any position within the surrounding space. Though the relative positions of the listener and of the electroacoustic converters outputting the acoustic information remain spatially fixed, it is possible to awaken in the listener the subjective impression that the sound-generating source is turning around him, moving toward him, moving away from him, or changing in some other way. By signal processing of the sound information, the sound-generating source can be positioned anywhere in space, yet give the impression to the user that it is located elsewhere.

### SUMMARY OF THE INVENTION

According to the invention, a virtual assistant which outputs audible information to a data terminal user by means of at least two electroacoustic converters can be spatially positioned by the user in order to achieve a better spatially acoustic separation between the information output by means of the electroacoustic converters and additional information output by at least one other sound source.

An advantage of is that signal processing of the sound information of the virtual assistant may utilize the spatial positioning of the sound sources of relative to the data terminal user so that the virtual assistant can be better perceived separately from ambient noise.

Furthermore, the sound information of the virtual assistant can be supplied to the data terminal user in a targeted manner from a specific direction, while the user is simultaneously holding a conversation with someone else in the room. Here, too, it is possible to achieve satisfactory spatially acoustic separation between the sound information acting on the user from the virtual assistant and from the person conversing with the user. This enables the user to receive and process both the information coming from the virtual assistant and the information coming from his conversation partner. The simultaneous reception and processing of both sets of information is at least facilitated for the user.

A further advantage emerges when, in addition to the sound information coming from the virtual assistant and the ambient noises originating from other sound sources present in the vicinity of the user, visual information is also presented to the data terminal user at the same time. In this case, too, the data terminal user can better receive and process the information coming from the various sources.

Additional features and advantages of the present invention are described in, and will be apparent from, the following Detailed Description of the Invention and the figures.

### DETAILED DESCRIPTION OF THE INVENTION

In a first embodiment, a pedestrian is situated in road traffic. The pedestrian is laden with heavy shopping bags. The pedestrian would like to conduct a phone call using his data terminal in the form of a mobile phone. The mobile phone is switched on, but is stowed away in one of his shopping bags and therefore cannot be readily located. The pedestrian is wearing a light headphones and microphone set however. Integrated in the headphones and microphone set are two electroacoustic converters for outputting sound information. Like the mobile phone, the headphones and microphone set is connected to a radio module, for example to a Bluetooth radio module, for short-range data exchange between the headphones and microphone set and the mobile phone.

The pedestrian, user of the headphones and microphone set and of the mobile phone respectively, activates the headphones and microphone set and thus enables data exchange between the headphones and microphone set and the mobile phone. The user speaks the word “DIAL” into the headphones and microphone set, whereupon the virtual assistant of the mobile phone responds with “PLEASE SAY THE NAME”. The user says the name of the person he wishes to call. Since the user is moving in an environment with a high noise level, the mobile phone does not recognize the name of the person to be called with sufficient accuracy. The mobile phone processes the name entered by the user and compares it with names stored in the internal phone directory of the mobile phone. The mobile phone recognizes the name spoken as “SCHMITZER” or “SCHNITZLER”. Output of the two names to the display unit of the mobile phone and the subsequent request to the user to select one of these names is of no use to the user because, as already mentioned, the user's mobile phone is hidden in one of the pedestrian's shopping bags in a place that is difficult to access. However, the mobile phone has recognized the request by the user via the headphones and microphone set, so the mobile phone instructs the virtual assistant to output all similarly sounding names to the user by means of the headphones and microphone set. For example, the user hears the following words of his virtual assistant via the headphones and microphone set: “THE NAME WAS NOT CLEARLY RECOGNIZED”. “PLEASE SELECT ONE OF THE FOLLOWING OPTIONS”. “SCHMITZER” or after a brief pause “SCHNITZLER”.

Despite the loud ambient noises, the user recognizes both the options offered by the virtual assistant because binaural technology is used during the output of the sound information of the virtual assistant of the mobile phone by means of the electroacoustic converters. The binaural technology enables targeted signal processing of the sound information output by the mobile phone. When the sound information is played back by the virtual assistant using the headphones and microphone set, the mobile phone user can perceive a clear local attribution of the sound information output by the virtual assistant. In accordance with a user preset in the mobile phone, the sound information is processed using signal technology in such a way that the mobile phone user locates the sound information presented by the virtual assistant as if it were coming from the vicinity of the head. The sound information is “whispered” into the user's ear over his shoulder from behind.

The position of the virtual assistant, or the position from which the sound information output by the virtual assistant is perceived respectively, can be changed as desired by the mobile phone user, for example by means of an electromechanical input device as is well known in the art.

The electromechanical input device may be for example a ball-in-socket input device, where the rotations of the ball produced by the user are detected by sensors. Alternatively, the positioning of the virtual assistant may be performed by means of voice commands or by means of inputs on a touch-sensitive display unit of the mobile phone.

If the mobile phone has a head position sensor which detects the head movements of the mobile phone user, for example using a rotational rate sensor or a magnetic field sensor, it is furthermore possible for the selected position of the virtual assistant to be retained even if the head movements are taken into account during the signal processing of the sound information.

By means of the preset positioning of the virtual assistant, or the ability of the user to change its position as desired, the user can both operate the mobile phone in a simple manner using voice commands to establish an outgoing connection as well as attentively perceive ambient noises, such as loud calls or the sounding of horns etc.

To finish the selection of the names “SCHMITZER” or “SCHNITZLER” presented by the virtual assistant in order to establish an outgoing connection, the user responds to the name “SCHMITZER” by speaking a “NO” into the headphones and microphone set and by responding “YES” for the name “SCHNITZLER”. The mobile phone recognizes the name “SCHNITZLER” and establishes an outgoing call.

In a second embodiment, a teleconference is established among a plurality of people, many of whom speak and understand different languages. The participants in the teleconference are situated at individual tables spread throughout a teleconferencing room. Each person has their own display. If one participant starts to speak, a data terminal in the form of a teleconferencing system displays the participant on a large screen on a side wall of the teleconferencing room, so that the other participants can observe the facial expressions and gestures of the participant who is speaking.

Secondly, the speaker's speech is output via electroacoustic converters in the form of loudspeakers which are connected to the teleconferencing system.

At the same time, the speaker' speech is simultaneously interpreted into the languages of the other participants. The translations are made available to the participants in the form of sound information via headphones and microphone sets in which two electroacoustic converters for outputting sound information are integrated. To offer the participants the option of attentively following the speech both in the language of the participant speaking and in the language of the simultaneous interpretation, the simultaneous interpretation is output by the teleconferencing system using a virtual assistant so that the other participants can hear it. The virtual assistant can be positioned anywhere in the room by each teleconference participant by entering the respective key combinations into the teleconferencing system.

Here, too, the positioning of the virtual assistant, or the spatially acoustic perception of the sound information output by the virtual assistant by the individual participants respectively, is achieved by means of signal processing of the sound information in the teleconferencing system. The participants position the virtual assistant in such a way that the participants perceive the output of the sound information by the virtual assistant as being transmitted over the shoulder from behind and coming from the vicinity of the head. By virtue of this positioning of the virtual assistant, a good spatially acoustic separation between the speech transmitted via loudspeakers and the simultaneous interpretation of the speech is achieved. The participants can readily follow both the speech transmitted via loudspeakers and the simultaneous translation while attentively observing the facial expressions and gestures of the participant speaking. That is to say, the participants can attentively follow a plurality of information streams at the same time.

If one participant already knows what one of his own delegation is going to say, then said participant can have the teleconferencing system acoustically give him further information via the virtual assistant, for example about the schedule for the day, background information about the other participants, or information about the participant's hotel.

The above embodiments of the invention are merely examples and are not exhaustive. The concept of spatially acoustic separation and signal processing of sound information which is output to a data terminal user via a virtual assistant and additional simultaneously audible and/or visible information which is important to the user can be applied to further examples. In particular, the present invention may also be employed in cases where mobile communication terminals are employed by a user. Travel guides are cited here by way of example, wherein the travel guide explains certain exhibits of a museum to visitors in the local language of the museum; the visitors are able to listen to a simultaneous translation of the explanations of the travel guide on their UMTS mobile phone having good spatially acoustic separation via a virtual assistant. Optionally the user can attentively follow additional optical information relating to the exhibits on the display unit of their UMTS mobile phone at the same time.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-10. (canceled)

11. A virtual assistant comprising:
a data terminal;
at least two electroacoustic converters; and
at least one other sound source;
said at least two electroacoustic converters being driven such that the virtual assistant can be spatially positioned by a data terminal user to achieve acoustic separation between the electrostatic converters and at least one other sound source.

12. The virtual assistant as claimed in claim 1, wherein the spatial positioning of the virtual assistant is achieved by targeted signal processing of the sound information from the data terminal.

13. The virtual assistant as claimed in claim 1, wherein the virtual assistant can be positioned by the user to be located in the vicinity of the user's head and behind one of the user's shoulders.

14. The virtual assistant as claimed in claim 1 wherein the spatial positioning of the virtual assistant can be preset.

15. The virtual assistant as claimed in claim 1 further comprising an electromechanical input device for receiving user input to set the positioning of the virtual assistant can be set by means of an electromechanical input device.

16. The virtual assistant as claimed in claim 1 wherein the positioning of the virtual assistant can be set by means of voice commands.

17. The virtual assistant as claimed in claim 1, characterized in that the positioning of the virtual assistant can be set by means of inputs entered on a touch-sensitive display unit.

18. The virtual assistant as claimed in claim 1 the data terminal comprises mobile data terminals.

19. A method of providing audible information to a terminal user comprising the steps of:
providing at least two electroacoustic converters;
processing signals containing the audible information; and
driving the electroacoustic converters with said processed signals such that an apparent source of the audible information can be positioned, and the spatial acoustic separation between the information output by the electroacoustic converters and at least one additional sound source can be improved.

20. The method as claimed in claim 9, further comprising a head position sensor which records the head movements of the data terminal user; and
taking into account the user's head movements while processing the signals containing the audible information in such a way that the selected spatial position of the apparent source of the audible information remains unchanged relative to the user's head even if the user's head moves.
